(19) United States
(12) Patent Application Publication
(10) Pub. No.: US 2005/0234773 A1
(43) Pub. Date: Oct. 20, 2005

(54) Credit card mileage rewards program, system and method

(76) Inventors: Alexis Hirst, New York, NY (US); Jacqueline Miller, West Orange, NJ (US); Jayastu Bhattacharya, New York, NY (US); Parris Hall, Philadelphia, PA (US); Steven Freiberg, Jericho, NY (US); Vikram Atal, New York, NY (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/096,116

(22) Filed: Mar. 31, 2005

Related U.S. Application Data
(63) Continuation-in-part of application No. 10/824,935, filed on Apr. 15, 2004.
(60) Provisional application No. 60/627,565, filed on Nov. 12, 2004.

(51) Int. Cl. G06F 17/60

(52) U.S. Cl. 705/14; 235/380

(57) ABSTRACT

A system and method for enhancing the value and desirability of a financial relationship between a customer and a bank or other financial institution through a rewards program which provides the customer with a benefit based on not only qualifying financial activity but on miles driven in a vehicle associated with the customer.

### CROSS REFERENCE TO RELATED APPLICATIONS

This application claims the benefit of U.S. Provisional Patent Application No. 60/627,565 filed on Nov. 12, 2004. This application is a continuation-in-part of U.S. patent application Ser. No. 10/824,935 filed on Apr. 15, 2004.

### BACKGROUND OF THE INVENTION

The present invention is directed to a system and method for enhancing the value and desirability of a financial relationship between a customer and a bank or other financial institution through a rewards program which provides the customer with a benefit based on not only qualifying financial activity but on miles driven in a vehicle used by a customer (e.g., automobile, motorcycle, bicycle etc.). The present invention has particular utility with respect to financial relationships/activity/transactions involving credit cards, bank cards, charge cards, debit cards, ATM cards or other payment products, and is described hereinafter principally in the context of a credit card payment product. It should be understood, however, that the present invention is not limited in application to credit cards or the other payment products listed above, but also has application with respect to financial relationships/activity/transactions involving other financial products and services, including, without limitation, loan products and investment servicing.

Payment products such as, for example, credit cards allow card holders to pay for services and/or merchandise without using cash at the time of purchase. Credit cards are generally issued by a bank or other financial institution and provide a mechanism by which a card holder can receive a temporary loan from the bank for the purpose of paying for the purchase. The card holder may thereafter either pay the outstanding balance or, as a matter of choice, defer the balance for later payment with accompanying interest or finance charges for the period during which payment of the debt is deferred.

Credit cards are ubiquitous in today's society. Many consumers have more than one credit card and regularly use different credit cards to make their various purchases. Banks and financial institutions issue credit cards and service credit card accounts. The issuer may also generate revenue through a per transaction fee or commission charged to retailers and other merchants when the retailer processes a credit card holder's purchase, and from finance charges accrued when the credit card holder incurs a revolving balance on that issuer's credit card.

A credit card issuer would prefer that card holders predominantly use that issuer's credit card in order to generate the largest amount of fees and revenue. Therefore, the credit card issuer may offer incentives to card holders who use that issuer's card. Often the incentives are accumulated when the card holder uses the credit card. This benefits the card issuer because, with credit card usage, comes the opportunity for the card issuer to generate fees and revenue.

Banks and other financial institutions can also offer credit cards that provide the credit card holder with a particular benefit every time a purchase of goods or services using that card is made as an incentive for the credit card holder to use their credit card. For example, the benefit may be a certain amount of frequent flyer miles, or a discount voucher good toward the purchase of a gift or other merchandise. These benefits are vigorously promoted by the banks or card issuing organizations.

Credit cards are also being issued by banks and financial institutions in association with other commercial companies or businesses which themselves offer goods and/or services. This phenomenon, known as co-branding, provides a credit card that often carries the name of the commercial company along with the issuer's name. The commercial company often provides the credit card holder certain benefits which are typically related to the goods or services provided by that commercial company. An example of a co-branded credit card is the General Motors card (MASTERCARD or VISA) which offers credit card holders 5% earnings on card purchases toward the purchase or lease of a new General Motors vehicle.

An opportunity exists for a new rewards program which provides incentives for spending (especially, vehicle-related spending) by customers of banks or other financial institutions by offering valuable benefits to such customers based on not only qualifying financial activity, but on miles they drive in their vehicles.

### SUMMARY OF THE INVENTION

Generally speaking, a system and method is provided for rewarding a customer of a bank or other financial institution based on not only a qualifying transaction or other financial activity, but on miles traveled in the customer's vehicle.

In accordance with one embodiment of the system and method of the present invention, a bank or other financial institution issues a credit card or other payment product to a consumer whereby the card holder automatically earns a percentage of their accumulated qualifying purchases made with the card in a given period as a reward. Such rewards may also be earned based on cash advances and transfers of credit balances to the credit card account; or rewards may be earned based on finance charges incurred. For every such reward earned, the card holder can automatically earn an additional reward (e.g., equal to a percentage of card purchases) based on miles driven in a vehicle associated with the card holder in the applicable period.

The card holder may be entitled to receive enhanced reward amounts associated with the additional reward based on miles driven when the card holder purchases goods or services from specified (by the card issuer) goods/services providers (preferably, automotive-related).

The earned reward may be in the form of a rebate, which can be issued to the card holder in the form of a check or applied to the card holder's credit card balance. Earned rewards can also accrue in the form of points and can be redeemed for a variety of goods and/or services (e.g., vehicle servicing) offered for selection to the card holder—including, for example, through a catalog or Internet Web site accessible to the card holder. The card issuer or its fulfillment agent is responsible for fulfilling reward redemptions.

In order to take advantage of the rewards program according to embodiments of the present invention, the card holder initially provides the card issuer or its agent with a benchmark mileage number for the card holder's vehicle (preferably, limited to one vehicle per credit card account). The card holder subsequently periodically updates the mileage information (desirably, at least once during each credit card billing cycle, e.g. monthly) so that appropriate rewards can be calculated. Suitable verification of mileage may be required by the card issuer or its agent as a prerequisite to earning rewards based on miles driven (e.g., by submitting vehicle inspection documentation or vehicle service receipts).

According to an alternative embodiment of the present invention, fuel purchases made with the card are automatically used to calculate mileage driven based on, for example, the vehicle make, model and/or type without the need for the card holder to supply mileage verification documentation to the card issuer. To this end, fuel economy information for the vehicle is provided by the card holder at enrollment in the rewards program according to the present invention or obtained independently by the card issuer or its agent based at least on the make, model and year of the vehicle.

The qualifying transaction information and the mileage data are used to calculate the appropriate reward earned by the card holder based on rules or other criteria which can reside in a system database of the card issuer or its agent which can include one or more control files or look-up tables.

According to other alternative embodiments of the present invention, transactions attendant to relationships between the customer and the financial institution other than associated with payment products per se (e.g., in connection with mortgage loans, investment servicing, etc.) can form the underlying foundation for rewards based on miles traveled in the card holder's vehicle. Earned rewards associated with such transactions and based on vehicle mileage can take the form of reduced rates on loans, for example.

It is accordingly an object of the present invention to provide a new rewards program for enhancing the value and desirability of a financial relationship between a customer and a bank or other financial institution which provides the customer with a benefit based on not only qualifying financial activity but on miles traveled in a vehicle associated with the customer.

It is a further object of the present invention to provide a program for enhancing the value of a credit card or other payment product to a credit card holder and encouraging increased use of the credit card as a payment device by rewarding the card holder based on qualifying purchases using the card and on the card holder's vehicle mileage.

The foregoing and other aspects, features and advantages of the invention will in part be obvious and will in part be apparent from this disclosure and accompanying drawing.

The present invention accordingly comprises the features of construction, and combination and arrangement of elements, as well as the several steps and the relation of one or more of such steps with respect to each of the others, all as exemplified in the following detailed disclosure and accompanying drawing, and the scope of the invention will be indicated in the claims.

### BRIEF DESCRIPTION OF THE DRAWING

For a fuller understanding of the invention, reference is had to the following description taken in connection with the accompanying drawing, in which:

FIG. 1 is a high-level flow chart depicting the process flow in effecting a credit card rewards program according to one embodiment of the system and method of the present invention; and

FIGS. 2-5 are flow charts/timelines depicting practical examples of process flows for alternative implementations of a credit card rewards program according to alternative embodiments of the system and method of the present invention.

### DETAILED DESCRIPTION OF THE PREFERRED EMBODIMENT

The present invention is directed to enhancing the value and desirability of a financial relationship between a customer and a bank or other financial institution through a rewards program system and method which provide the customer with a benefit based on not only qualifying financial activity but on miles driven in the customer's automobile, motorcycle, bicycle or other vehicle (which can include rental vehicles). While it should be understood that the present invention has applicability with respect to financial relationships/activity/transactions involving credit cards or other payment products (e.g., including charge cards, bank cards, smart cards, ATM cards, debit cards, etc., including co-branded and “private label” products) as well as other financial products and services, including, without limitation, loan products and investment servicing, for ease of explanation, the present invention is described herein principally in the context of a credit card payment product.

The system and method according to the present invention can be implemented using a related combination of automated interfaces and manual processes. It should be appreciated, however, that greater use of automated processing and a wider range of features with multiple executions is also contemplated by the present invention.

In so far as embodiments of the invention described herein are implemented, at least in part, using software controlled programmable processing devices, such as a computer system, it will be appreciated that one or more computer programs for configuring such programmable devices or system of devices are to be considered an aspect of the present invention. The computer programs can be embodied as source code and undergo compilation for implementation on processing devices or a system of devices, or can be embodied as object code, for example. Those of ordinary skill in the art will readily understand that the term computer in its most general sense encompasses programmable devices such as those referred to above, and data processing apparatus, computer systems and the like. Preferably, the computer programs are stored on carrier media in machine or device readable form, for example in solid-state memory or magnetic memory, and processing devices utilize the programs or parts thereof to configure themselves for operation.

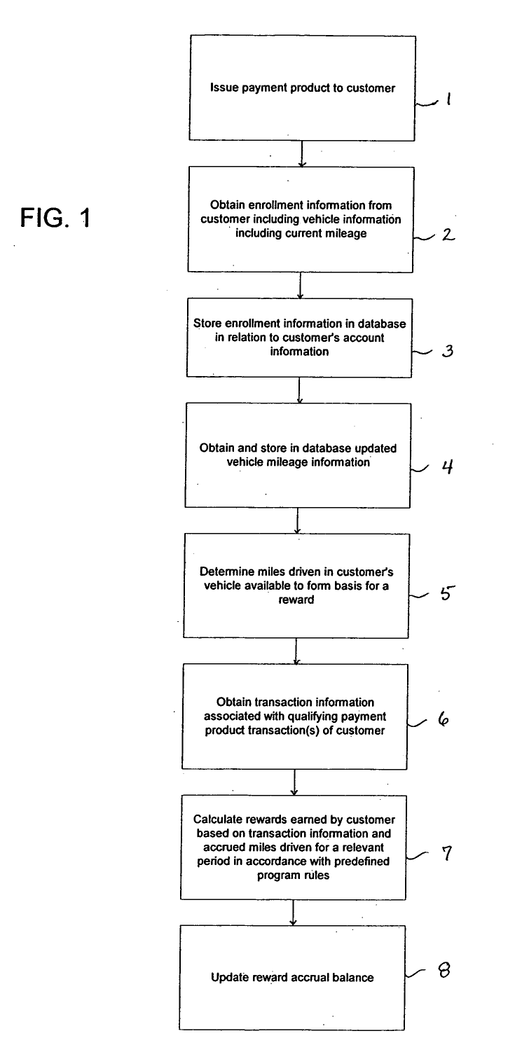

Referring now to FIG. 1, there are shown steps involved in effecting a rewards program in accordance with one embodiment of the present invention rewarding use of a credit card or other payment product. As an initial step, a bank or other financial institution issues a credit card or other payment product to a customer [step 1].

In order to take advantage of the rewards program according to the present invention, the card holder desirably first enrolls in the program, e.g., by submitting an enrollment form or the like (electronically “on-line” or otherwise) [step 2]. This involves providing the card issuer or its agent with information concerning the card holder's vehicle (e.g., VIN number, vehicle type, make, model, year, and/or license plate number) together with the current mileage of the card holder's vehicle and, preferably, supporting documentary evidence of the mileage figure (e.g., odometer reading). As will be appreciated, the vehicle mileage information provided at enrollment serves as a benchmark for the calculation of rewards based on miles driven.

The vehicle identification and mileage information provided by the card holder is preferably stored in a database of the issuing financial institution in relation to the card holder's credit card or other financial account information [step 3].

If the card holder sells their vehicle, or wishes to enroll a different vehicle, the card holder may enroll any new vehicle according to the above procedure. The system database would then be updated with the new vehicle information and a new mileage benchmark established. Also, desirably, the replacement of an enrolled vehicle with a newly-enrolled vehicle will not result in a loss to the card holder of any banked miles—once miles are earned, they are available to be redeemed in accordance with the rewards program rules.

While it is preferred to limit the card holder to enrolling one vehicle per credit card account, this should not be viewed as foreclosing the ability to enroll multiple vehicles per account.

As the card holder makes purchases using the credit card, the card holder automatically earns a percentage of their accumulated qualifying purchases made with the card in a given period as a rebate or as points that may be redeemed for a benefit. Such rewards may also be earned based on cash advances and transfers of credit balances to the credit card account and the like. As a preferred example, card holders can earn a reward equal to 1% of qualifying purchases made with the card. It should be appreciated that the reward percentage for qualifying purchases may be other than 1% and can be set at the discretion of the credit card issuer.

According to the present invention, for every such reward earned, the card holder can automatically earn an additional reward (e.g., having a value equal to a percentage of card purchases) based on miles driven in the vehicle associated with the card holder in the applicable period. As a preferred example, card holders can earn a rebate equal to 1% of card purchases for every mile driven (or 1 reward point for every mile driven) up to the purchase amount on the card.

It should be appreciated that the reward percentage associated with miles driven may be other than 1% and can be set and adjusted at the discretion of the credit card issuer. Also, different reward percentages can be applied for different time periods and/or based on the nature of the underlying basis for reward eligibility (e.g., whether the reward is based on a credit card transaction or on a loan transaction or other financial activity) at the discretion of the credit card issuer.

In connection with the foregoing, the card holder periodically provides the credit card issuer or its agent with updated vehicle mileage information [step 4]. Desirably, this is done at least once during each credit card billing cycle—e.g., on a monthly basis. Preferably, the updated mileage information is accompanied by supporting documents or other mileage verifying evidence (e.g., vehicle inspection documentation, vehicle service documentation, vehicle rental documentation, etc.). The updated mileage information is stored in the system database.

The number of miles driven which have not yet formed the basis for a reward in accordance with the system and method of the present invention (e.g., calculated as new miles minus miles at enrollment for the first mileage update since enrollment) become the card holder's accrued miles bank (residing in the system database) [step 5].

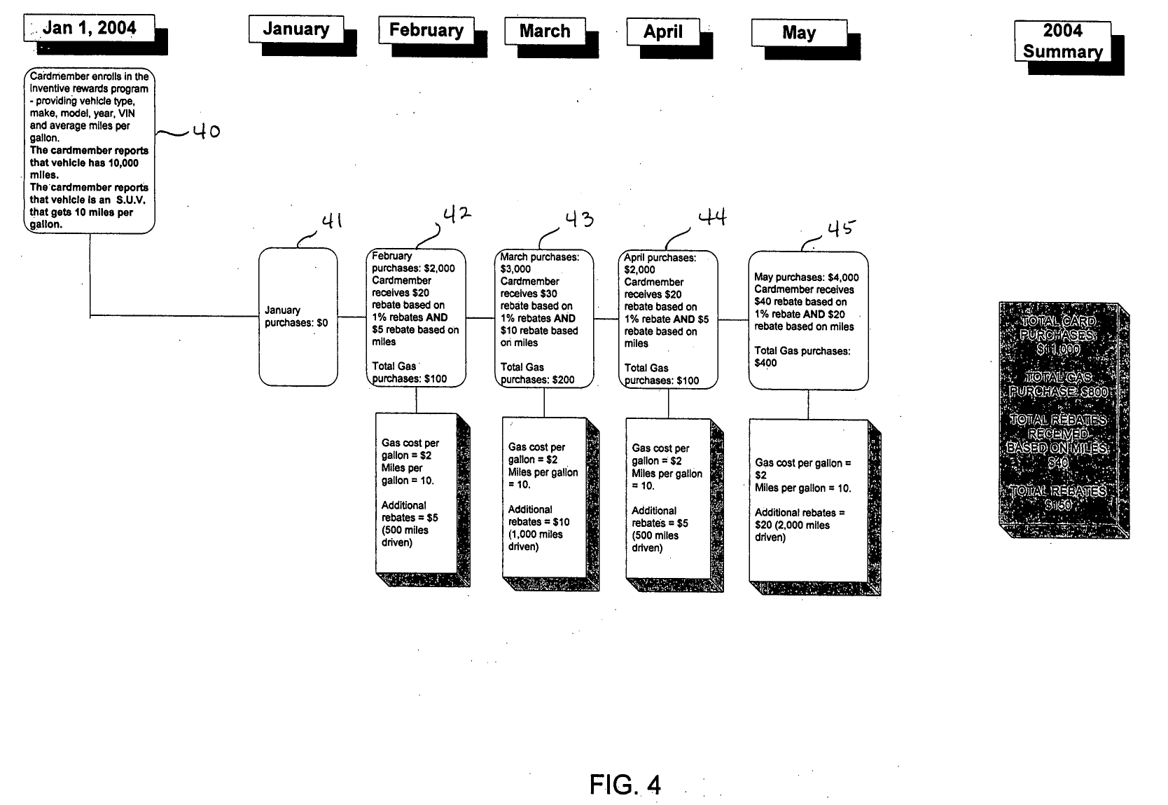

According to an alternative embodiment of the present invention discussed in greater detail below in connection with FIG. 4, mileage data can also be automatically obtained in association with the credit card transaction information without being voluntarily supplied by the card holder when the card holder uses the card to purchase fuel.

If mileage information associated with a vehicle other than an enrolled vehicle is submitted by the card holder, the program according to the present invention can automatically reject such submission.

It should be appreciated that no information need be provided by the card holder to establish the qualifying purchase—the card issuer has this information automatically.

For each predefined relevant period (e.g., month), the transaction information associated with qualifying purchases made with the card [step 6] and the accompanying mileage information (stored in the database) are used by the card issuer to calculate the appropriate reward earned by the card holder for the period by applying such data to predetermined rules or other criteria which can reside in one or more control files or look-up tables in a system database [step 7]. Newly-earned rewards are added to any accrual balance or tally of rewards; redeemed rewards are deducted therefrom (i.e., the bank updates the card holder's rewards accrual balance) [step 8].

While it is preferred that rewards cannot exceed purchases made (despite the number of miles in the card holder's accrued miles bank), it should be appreciated that the card issuer can, at its discretion, provide for redemption of rewards based solely on accrued miles regardless of any purchase amount or other limitations (particularly, when the underlying basis for the reward is not a purchase transaction—e.g., a loan transaction). Also, rewards based on mileage are not available if the card holder's accrued miles bank is depleted. Furthermore, it should be appreciated that, at the discretion of the credit card issuer, a cap on rewards earned by the card holder in any period may be established.

Desirably, the foregoing process with respect to rewards based on mileage according to the present invention continues for a preselected time frame at the discretion of the card issuer (e.g., 12 months, indefinitely or some other time period) or until all of the card holder's accrued miles are used, whichever occurs first. Also, card holders desirably may not be entitled to receive rewards when their credit card accounts are delinquent.

By way of example, the card holder makes purchases using the credit card according to the present invention totaling $500 in a given period (e.g., month). The card holder also has “banked” (accrued) a total of 10,000 miles over and above the benchmark set at enrollment, which miles have not yet formed the basis for a reward in accordance with the system and method of the present invention. Under the rewards program according to a preferred embodiment of the present invention, the card holder can be entitled to a rebate or redeemable rewards points for the period (e.g., month) in an amount equal to a predefined percentage (e.g., 1%) of the purchase amount ($5), as well as an additional rebate/rewards points in an amount equal to a predefined percentage (e.g., 1%) of the purchase amount ($5) which, assuming, for example, that 100 miles is predetermined to equate to $1 in rewards, translates into 500 miles redeemed leaving 9,500 miles eligible for future redemption. Additional qualifying purchases and additional miles driven can entitle the card holder to additional rewards.

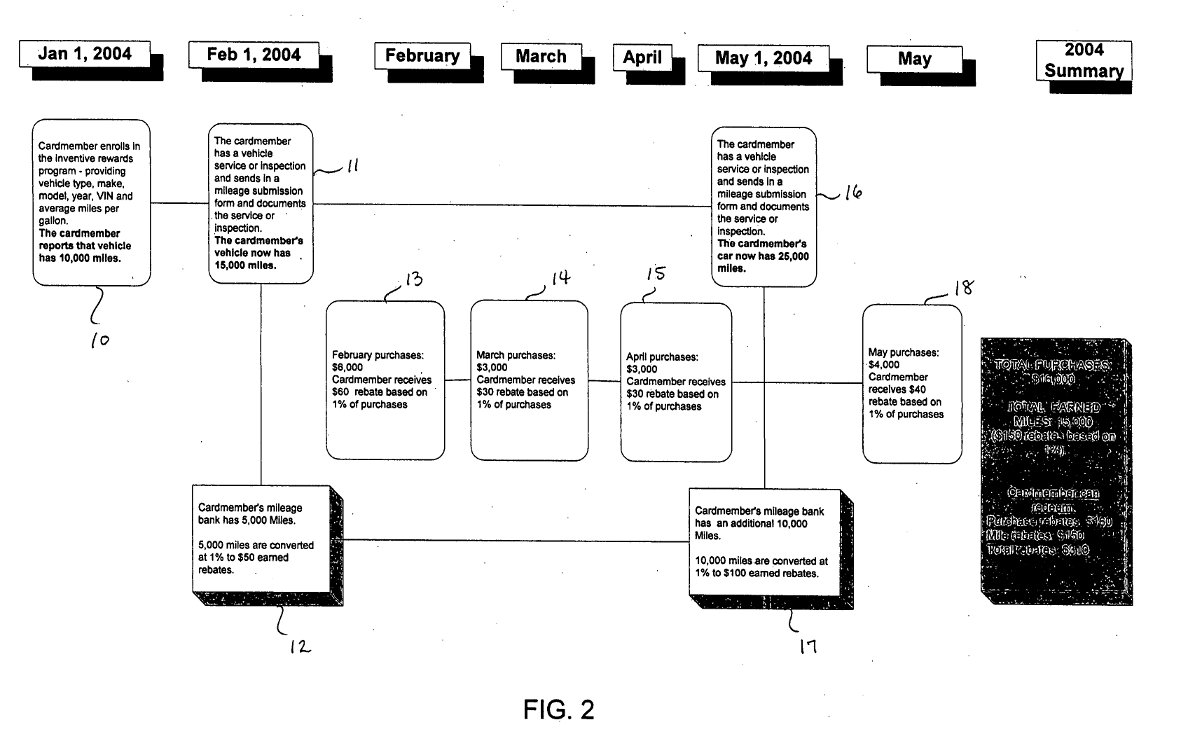

As an alternative example, referring to the timeline of events and steps depicted in FIG. 2, the card holder enrolls in the rewards program according to one embodiment of the present invention in January 2004 with 10,000 miles on the odometer [event 10]. In February 2004, the card holder obtains a vehicle service or inspection for the enrolled vehicle and submits associated documentation to the card issuer establishing 15,000 miles on the odometer [event 11]. This translates into 5,000 miles available as a basis for a reward according to the present invention; and, assuming, for example, that 100 miles is predefined to equate to $1 in mileage rewards, a reward of $50 based on the 5,000 miles banked is earned by the card holder [event 12]. During the month of February, the card holder makes $6,000 worth of purchases using the card and, based thereon, earns a reward for the period in an amount equal to the predefined percentage (in this example, 1%) of the purchase amount ($60) [event 13]; in March, the card holder makes $3,000 worth of purchases using the card and, as a result, earns a reward for the period of $30 [event 14]; and in April, the card holder makes another $3,000 worth of purchases using the card and, as a result, earns a reward for the period of $30 [event 15]. In May, 2004, the card holder obtains another vehicle service or inspection for the enrolled vehicle and submits associated documentation to the card issuer establishing 25,000 miles on the odometer [event 16]. This translates into 10,000 miles available as a basis for an additional reward according to the present invention and a reward of $100 based thereon [event 17]. Also, during the month of May, the card holder makes $4,000 worth of purchases using the card and, as a result, earns a further reward for the period of $40 [event 18].

In the embodiment of the rewards program according to the present invention illustrated in FIG. 2, rewards based on mileage continue for a 12 month timeframe measured from each discrete new mileage submission by the card holder. It should be appreciated that a time frame other than 12 months can be utilized—the time frame being established at the sole discretion of the card issuer.

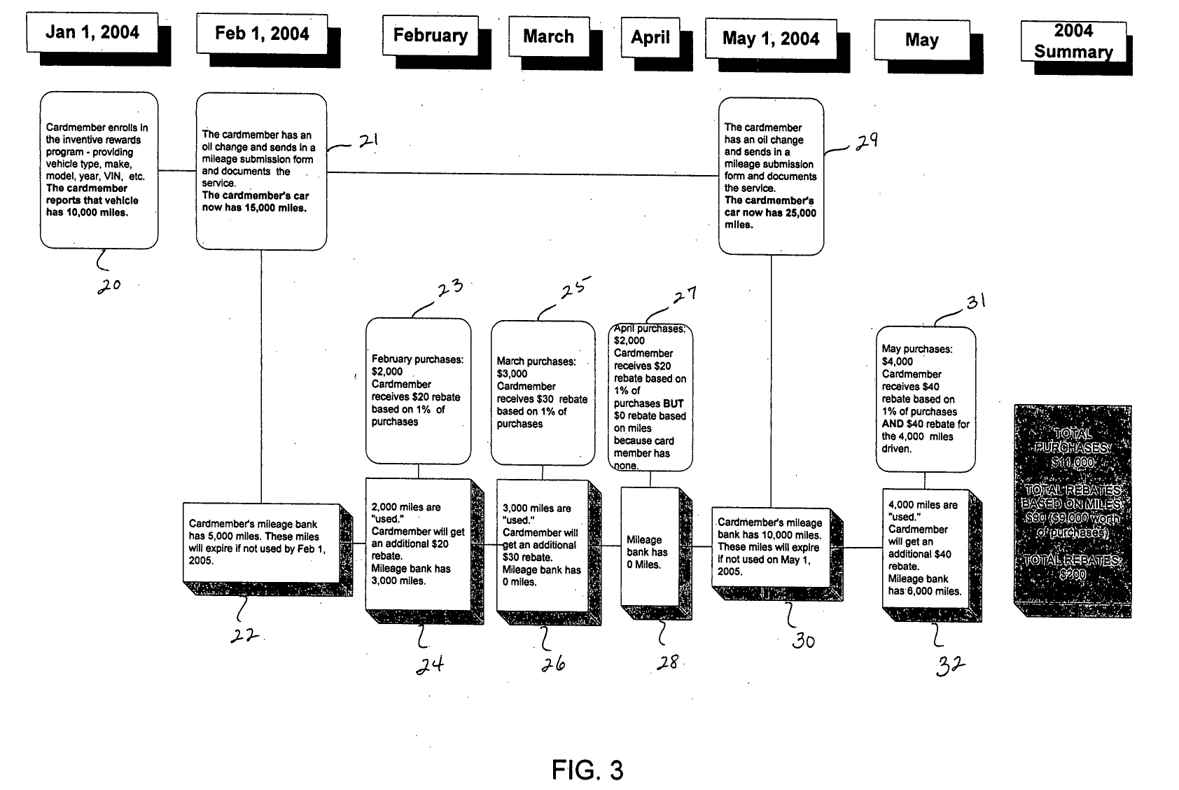

As another example, referring to FIG. 3, the card holder enrolls in the rewards program according to one embodiment of the present invention in January 2004 with 10,000 miles on the odometer [event 20]. In February 2004, the card holder obtains an oil change for the enrolled vehicle and submits associated documentation to the card issuer establishing 15,000 miles on the odometer [event 21]—this translates into 5,000 miles banked and unused as a basis for a reward according to the present invention [event 22]. During the month of February, the card holder makes $2,000 worth of purchases using the card and, as a result, is entitled to a reward for the period in an amount equal to the predefined percentage (e.g., 1%) of the purchase amount ($20) [event 23], as well as an additional reward in an amount equal to the predefined percentage (e.g., 1%) of the purchase amount ($20) which uses 2,000 miles of the 5,000 miles banked (leaving 3,000 miles banked) [event 24]. In March, the card holder makes $3,000 worth of purchases using the card and, as a result, is entitled to a reward for the period in an amount equal to $30 [event 25], as well as an additional reward in an amount equal to $30 which uses all of the banked 3,000 miles [event 26]. In April, the card holder makes $2,000 worth of purchases using the card and, as a result, is entitled to a reward for the period in an amount equal to $20 [event 27]—the card holder is not, however, entitled to receive an additional reward as the card holder's mileage bank is fully depleted [event 28]. In May, the card holder obtains another oil change for the enrolled vehicle and submits associated documentation to the card issuer establishing 25,000 miles on the odometer [event 29] enabling the card holder to bank 10,000 miles [event 30]. 4,000 of the newly-banked miles are subsequently used that month when the card holder makes $4,000 in card purchases entitling the card holder to a reward for the period in an amount equal to $40 in view of the purchases [event 31], as well as an additional reward in an amount equal to $40 in view of the miles driven [event 32].

As yet another example, the card holder makes purchases using the credit card according to the present invention totaling $300 in the relevant period. The card holder also has driven 1,000 miles over and above the benchmark set at enrollment. Under the rewards program according to an embodiment of the present invention, the card holder can be entitled to a rebate or redeemable rewards points for the period in an amount equal to the predefined percentage (e.g., 1%) of the purchase amount ($3), as well as additional rewards equaling $3 from 300 of the miles driven. The next period, the card holder spends $800 on the card but does not drive any additional miles—the card holder will earn $8 in rewards from purchases on the card and an additional $7 in rewards from the remaining 700 miles banked.

Additional examples (which assume a preset rewards percentage of 1% for rewards based on both qualifying purchases and miles driven and for which rewards program expiration periods are established by the card issuer at its discretion) are set forth below:

Example 1: The card holder registers for the inventive rewards program on January 1 with 1,000 miles. On June 1, the card holder submits paperwork for a date of service of January 15. This submission of mileage will not be counted (even though the card holder had registered for the rewards program) because the card holder made the submission beyond a preselected permitted time period measured from mileage verification established by the credit card issuer or its agent in the program rules (here, 90 days, for example).

Example 2: The card holder registers for the inventive program on January 1 with 1,000 miles. On June 1, the card holder submits paperwork for a date of service of May 15. The paperwork reflects current mileage to be at 3,000 miles. For the current billing cycle, the card holder has $4,000 in new purchases. With the additional rewards for miles driven being less than the amount purchased, the entire 2,000 miles (or $20 reward) can form the basis for an additional reward over and above the $40 dollar reward for qualifying purchases.

Example 3: The card holder registers for the inventive rewards program on January 1 with 1,000 miles. On June 1, the card holder submits paperwork for a date of service of May 15. The paperwork reflects current mileage to be at 3,000 miles. However, for the current billing cycle, the card holder has only $500 in new purchases. Therefore, only 500 rewards points ($5 rebate) can be awarded based on miles driven. The remaining 1,500 miles driven can be banked for a period of 12 months, for example—so, on July 1, if the card holder spends another $500 on the card, another 500 rewards points ($5 rebate) can be credited. The remaining 1,000 points may carry over for another 11 months, and so on.

Example 4: The card holder registers for the inventive rewards program on January 1 with 1,000 miles. On June 1, the card holder submits paperwork for a date of service of May 15. The paperwork reflects current mileage to be at 3,000 miles. For the current billing cycle, the card holder has $500 in new purchases. Therefore, 500 mileage rewards points ($5 rebate) can be awarded. The remaining 1,500 miles driven can be banked for a period of 12 months, for example. On July 1, the card holder submits more paperwork to reflect another 1,000 miles driven. The July billing cycle shows purchases to be at $2,000. The entire 1,500 miles from the first submission can form the basis for a reward, and 500 miles from the second submission can also form the basis for a reward. The remaining 500 miles from the second submission may carry over for up to 12 months.

It should be appreciated that, from the card holder's perspective, the credit card according to the present invention (as described in greater detail hereinafter) provides all the benefits of an ordinary credit card during use. For example, when the card holder makes a purchase and chooses to pay for the purchase using the credit card, the credit card (or credit card number) is provided to the merchant who processes the purchase in the conventional manner.

From the merchant's perspective, the credit card according to the present invention is handled the same way as an ordinary credit card. For example, in processing a credit card purchase, the merchant transmits information about the purchase to the bank or financial institution that issued the card (e.g., directly if a credit card association, e.g., MASTERCARD or VISA, is not implicated, or, if a credit card association is implicated, by way of the merchant's processing bank which transmits the transaction information to the credit card association which then transfers the information to the issuing bank or financial institution). The issuing bank or financial institution then pays the merchant the amount on the credit card receipt (minus any transaction fee or commission) in the conventional manner, typically by applying a credit to the merchant's account (e.g., at the processing bank). The credit card issuer then applies the amount of the purchase to the card holder's balance on the credit card.

Earned rebate rewards amounts can be issued to the card holder in the form of a check or applied to the card holder's credit card balance; earned mileage rewards points can be redeemed for a variety of goods and services, preferably offered for selection to the card holder through the card issuer or its agent, e.g., in a catalog or by means of an Internet Web site accessible to the card holder. The card issuer or its fulfillment agent is responsible for fulfilling reward redemptions.

Desirably, a monthly or other periodic statement from the credit card issuer to the credit card holder for a credit card in accordance with the present invention will include the card holder's current accrued rebates/rewards points.

According to another embodiment of the present invention, the card holder can be entitled to receive enhanced rewards based on miles driven when the card holder purchases goods or services from specified (by the card issuer) goods/services providers (preferably, automotive-related). In addition to the incentive of enhanced rewards for patronizing a select goods/services provider, the goods/services provider can assume the mileage update and verification function on behalf of the card holder (without action on the part of the card holder other than purchasing goods/services from the select provider).

Referring now to FIG. 4, there are shown, in the context of a practical example, a timeline of events and steps involved in effecting the credit card rewards program in accordance with an alternative embodiment of the present invention whereby vehicle fuel purchases are automatically used to calculate mileage driven without the need for the card holder to supply mileage verification documentation to the card issuer. In order to take advantage of this embodiment of the inventive rewards program, the card holder desirably first enrolls in the program by submitting an on-line enrollment form or the like, for example [event 40]. This involves providing the card issuer or its agent with information concerning the card holder's vehicle (e.g., VIN number, vehicle type, make, model, year, and/or license plate number), preferably including the vehicle's fuel type and average fuel economy, and the current mileage of the vehicle. In the example illustrated in FIG. 4, this occurs on Jan. 1, 2004.

Every applicable period (e.g., month), fuel purchases made with the card are automatically used to calculate mileage driven based on the vehicle type. For example, if the card holder's vehicle gets 10 miles per gallon of gasoline and the gasoline purchased by the card holder costs $2 per gallon, $100 in gasoline purchases using the card in February (FIG. 4, event 42) equates to about 500 miles driven; and under the inventive rewards program, this translates into 500 miles on which rewards may be based.

In the event that the fuel purchase price is not obtainable from the transaction detail, or if the card issuer otherwise desires, the card issuer can use a predetermined fuel price to calculate miles driven based on fuel purchases. The predetermined price can be based on the national average fuel price for the relevant period, for example.

Continuing with the example set forth in FIG. 4, with no card purchases in January [event 41], when the card holder's February card purchases total $2,000, the card holder can be entitled to a reward for the period in an amount equal to the predefined percentage (e.g., 1%) of the purchase amount ($20), as well as additional rewards equaling $5 based on the 500 miles driven [event 42]. In March, $200 in gasoline purchases using the card equates to about 1,000 more miles driven which translates into a reward for the period in an amount equal to 1% of the $3,000 March purchases amount ($30), as well as additional rewards equaling $10 based on the 1,000 miles driven [event 43]. In April, a reward of $20 based on $2,000 of purchases and an additional reward of $5 based on $100 of gas purchases (equating to 500 miles driven) are earned [event 44]; and in May, a reward of $40 based on $4,000 of purchases and an additional reward of $20 based on $400 of gas purchases (equating to 2,000 miles driven) are earned [event 45].

It should be understood that the vehicle fuel economy information used to calculate miles driven can be obtained by the card issuer independently (of the card holder) based at least on the vehicle make, model and year provided by the card holder at enrollment. For example, the card issuer can obtain fuel economy information from public sources such as the Environmental Protection Agency or from data made available by the Automobile Association of America. Also, a predetermined surrogate vehicle fuel economy established by the card issuer can be used instead of the vehicle fuel economy based on the subject vehicle's make, model and year. The surrogate fuel economy can be based on a national average vehicle fuel economy for all vehicle types, for example.

Additionally, when the actual fuel purchase price from the transaction detail is not available for use in the mileage calculation, the surrogate fuel price can be used based on information also readily obtainable from public sources. Furthermore, in the event that the vehicle's fuel economy information is not provided by the card holder or otherwise obtainable, or if the card issuer otherwise desires, a predetermined fuel economy value (e.g., by vehicle type or for all vehicle types) can be used to calculate miles driven.

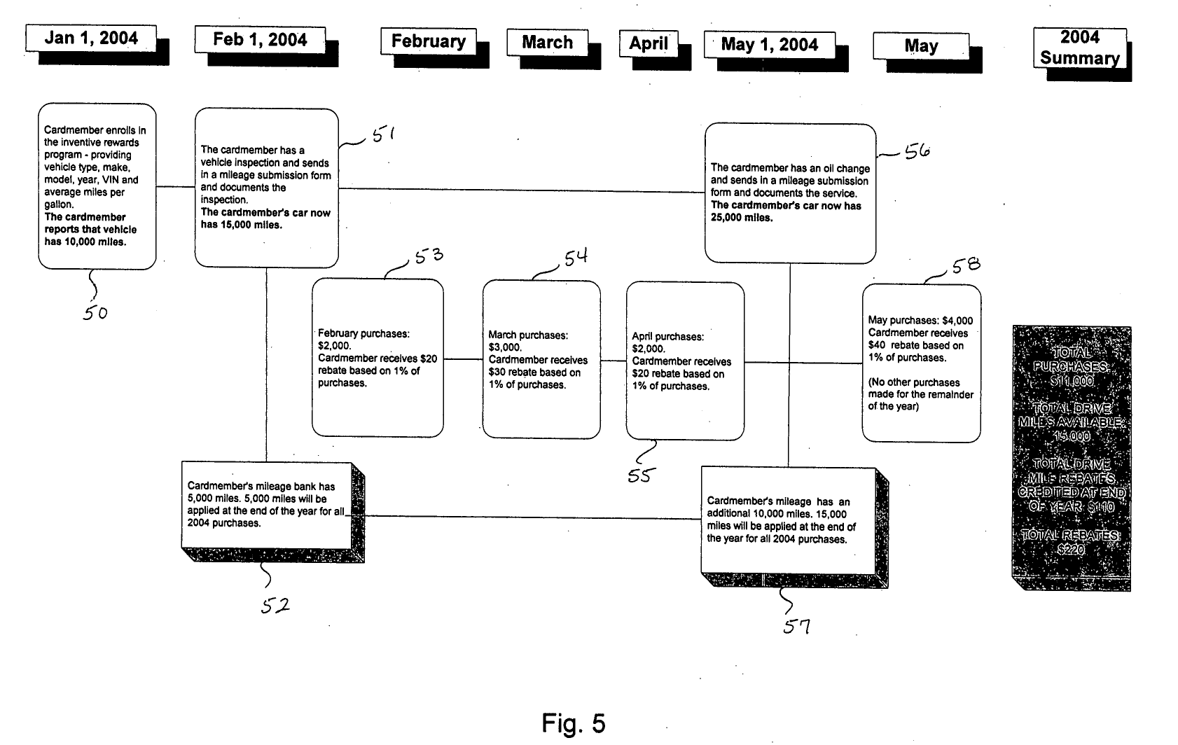

Referring now to FIG. 5, there are shown, in the context of a practical example, a timeline of events and steps involved in an alternative implementation of the credit card rewards program in accordance with the present invention whereby rewards based on miles driven are credited on an annual basis rather than periodically throughout the period. To take advantage of the inventive rewards program according to this embodiment, the card holder enrolls in the rewards program in January 2004 and submits information concerning the card holder's vehicle (e.g., VIN number, make, model, year, license plate number, fuel type, average fuel economy) and the current mileage of the vehicle—10,000 miles [event 50]. In February 2004, the card holder obtains a vehicle inspection for the enrolled vehicle and submits associated documentation to the card issuer establishing 15,000 miles on the odometer [event 51]—this translates into 5,000 miles banked [event 52]. During the month of February, the card holder makes $2,000 worth of purchases using the card and, as a result, is entitled to a reward for the period in an amount equal to the predefined percentage (e.g., 1%) of the purchase amount ($20) [event 53]; no additional rewards based on miles driven are awarded. In March and April, the card holder makes $3,000 and $2,000 worth of purchases, respectively, using the card and, as a result, is entitled to a $30 reward for March and a $20 reward for April [events 54 and 55, respectively]; no additional rewards based on miles driven are awarded in either March or April. In May, the card holder obtains an oil change for the enrolled vehicle and submits associated documentation to the card issuer establishing 25,000 miles on the odometer [event 56] enabling the card holder to bank an additional 10,000 miles, yielding 15,000 total miles banked [event 57]. In May, the card holder makes the last purchases of the year using the card totaling $4,000, and, as a result, is entitled to a $40 reward for May [event 58].

At year end, the card holder is entitled to receive an additional reward of $110 (over and above the $110 already awarded based solely on card purchases) representing the predefined percentage (e.g., 1%) of total purchases for the year ($11,000) which uses 11,000 miles of the 15,000 miles banked for the year. The remaining 4,000 banked miles may or may not carry over to the next annual period depending on the program rules established by the credit card issuer.

It should be understood that rewards in accordance with the inventive program can be based solely on the miles driven in the vehicle associated with the card holder in the applicable period up to a predetermined percentage of card purchases, and not in addition to rewards earned on qualifying purchases. Alternatively, rewards in accordance with the inventive program which are based solely on miles driven can be redeemed entirely irrespective of card purchases. It should be appreciated that the rules by which rewards based on miles driven can be redeemed in accordance with the present invention (whether or not based on card purchases or other financial transactions or activity) are established at the sole discretion of the financial institution offering the inventive program (e.g., the card issuer).

Furthermore, financial activity or transactions attendant to a service relationship between the customer and the financial institution other than associated with payment products per se (e.g., in connection with investment servicing, loans, such as, for example, automobile loans or mortgage loans, etc.) can form the underlying basis for rewards based on miles traveled in the customer's vehicle. Earned rewards associated with loan activity and based on vehicle mileage can take the form of reduced loan rates, for example.

Also, it should be appreciated that the credit card rewards program according to the present invention does not preclude the inclusion of additional features and benefits. For example, the credit card of the invention may include a color photo of the card holder bonded onto the credit card. The photo, in addition to helping to deter fraud if the card is lost or stolen, adds a visual identification to the merchant approval process.

Many credit card issuers can replace lost or stolen credit cards, typically within 24 hours of notice. In addition, credit card issuers may provide a service to help replace lost or stolen airline tickets, provide emergency cash up to the available credit advance limit on the credit card, and furnish information on how to replace important documents that may have also been lost or stolen. Additionally, credit card issuers may offer credit card holders insurance-type protection (e.g., covering travel mishaps).

Credit card issuers can also keep track and alert card members of unauthorized use of a credit card by monitoring purchase patterns. When unusual charges are noticed, card holders may be called and asked to verify that authorized card users are in fact making the charges.

Also, a toll-free number may be staffed by customer service representatives 365 days a year. Customer service can provide replacement cards and answer questions regarding customer accounts; it can also process hard copy enrollment or other program documents.

All of these additional benefits can be included along with the rewards program of the present invention.

In accordance with the foregoing, the present invention provides a program for enhancing the value and desirability of a financial relationship between a customer and a bank or other financial institution by rewarding the customer based not only on qualifying financial activity but also on miles driven in a vehicle associated with the customer. The program according to a preferred embodiment of the present invention encourages ongoing credit card spending since card holders will want to maximize additional rewards—which are earned based on miles driven up to amounts spent using the card.

In so far as embodiments of the invention described herein are implemented, at least in part, using software controlled programmable processing devices, such as a computer system, it will be appreciated that one or more computer programs for configuring such programmable devices or system of devices to implement the foregoing described rewards platform and program are to be considered an aspect of the present invention. The computer programs can be embodied as source code and undergo compilation for implementation on processing devices or a system of devices, or can be embodied as object code, for example. Those of ordinary skill in the art will readily understand that the term computer in its most general sense encompasses programmable devices such as those referred to above, and data processing apparatus, computer systems and the like. Preferably, the computer programs are stored on carrier media in machine or device readable form, for example in solid-state memory or magnetic memory such as disk or tape, and processing devices utilize the programs or parts thereof to configure themselves for operation.

It should be appreciated that the aspects, features and advantages made apparent from the foregoing and the accompanying drawing are efficiently attained and, since certain changes may be made in the disclosed constructions and processes without departing from the spirit and scope of the invention, it is intended that all matter contained herein and in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

1. A computerized method for rewarding use of a payment product by the payment product holder, the method comprising the steps of:
issuing a payment product from an issuer to a holder, said payment product representing funds available to said holder, said payment product providing means of payment for at least one transaction by said holder,
storing in at least one database information concerning a vehicle associated with said holder in associative relationship with information concerning said payment product, said vehicle information including a benchmark mileage of said vehicle,
automatically calculating a reward redeemable by said holder based on said at least one transaction and on miles traveled in said vehicle in excess of said benchmark mileage.

2. The method according to claim 1, further comprising the step of determining whether said at least one transaction using said payment product is a qualifying transaction in compliance with pre-defined rewards eligibility criteria of said issuer, and wherein said step of calculating a reward is effected only when said at least one transaction using said payment product is a qualifying transaction.

3. The method according to claim 1, further comprising the step of providing for redemption by said holder of at least a portion of said calculated reward.

4. The method according to claim 3, wherein the step of providing for redemption of at least a portion of said calculated reward includes presenting at least one benefit for selection by said holder in a catalog including at least one of goods and services.

5. The method according to claim 4, wherein said catalog is presented over a computer network.

6. The method according to claim 4, further comprising the step of fulfilling a request by said holder to redeem at least a portion of said calculated reward for said at least one benefit.

7. The method according to claim 6, wherein said step of fulfilling a request by said holder to redeem at least a portion of said calculated reward for said at least one benefit is effected by at least one of said issuer and a fulfillment representative of said issuer.

8. The method according to claim 6, wherein said calculated reward is accruable in an accrued rewards balance for said holder representing rewards earned by said holder less rewards redeemed by said holder, and wherein said step of fulfilling a request by said holder to redeem at least a portion of said calculated reward for said at least one benefit is effected when said accrued rewards balance is at least one of equal to and greater than a preselected threshold amount associated with said at least one benefit.

9. The method according to claim 1, further comprising the step of automatically calculating an additional reward based on said at least one transaction and on miles traveled in said vehicle in excess of said benchmark mileage redeemable by said holder when said at least one transaction includes the purchase of at least one of goods and services from a provider thereof preselected by at least one of said issuer and a fulfillment representative of said issuer.

10. The method according to claim 1, wherein said miles traveled in said vehicle in excess of said benchmark mileage is accruable in an accrued mileage balance for said holder.

11. The method according to claim 10, further comprising the step of updating said mileage balance based on an odometer reading for said vehicle associated with at least one of a service of said vehicle and an inspection of said vehicle.

12. The method according to claim 11, wherein said step of calculating a reward redeemable by said holder includes multiplying a monetary amount of said at least one transaction by a first percentage multiplier preselected by said issuer to yield a first reward component, multiplying said accrued mileage balance by a per mile monetary value preselected by said issuer to yield a second reward component, and multiplying said at least one transaction amount by a second preselected percentage multiplier proportional to said per mile monetary value to yield a second reward component cap, said reward equaling said second reward component up to said second reward component cap added to said first reward component.

13. The method according to claim 1, wherein said payment product is at least one of a credit card, a charge card, a debit card, a bank card, a smart card, and an automated teller machine card.

14. The method according to claim 1, wherein said vehicle information further includes at least one of a vehicle identification number, vehicle type, vehicle manufacturer, vehicle model, vehicle model year and license plate number.

15. The method according to claim 1, further comprising the step of providing said calculated reward to said holder in the form of a rebate payment.

16. The method according to claim 15, wherein said rebate payment is in the form of at least one of a check forwarded to said holder and a credit to a current account balance of said holder associated with said payment product.

17. The method according to claim 1, wherein said at least one transaction includes at least one of (i) cash advances made to said holder from said issuer, (ii) transfers of credit balances of said holder to a current account balance of said holder associated with said payment product, and (iii) finance charges incurred.

18. The method according to claim 1, wherein said step of calculating said reward is effected on a periodic basis.

19. The method according to claim 1, further comprising the step of verifying said benchmark mileage of said vehicle.

20. The method according to claim 1, further comprising the step of verifying said miles traveled in said vehicle in excess of said benchmark mileage.

21. The method according to claim 1, wherein said at least one transaction is a vehicle fuel purchase and said miles traveled in said vehicle in excess of said benchmark mileage is accruable in an accrued mileage balance for said holder, and further comprising the step of automatically updating said mileage balance based on said fuel purchase transaction.

22. The method according to claim 21, wherein said vehicle information further includes a fuel economy value for said vehicle, and said step of automatically updating said mileage balance based on said fuel purchase transaction includes dividing a fuel purchase total for said transaction by a price of fuel purchased to yield a quantity of fuel purchased, multiplying said calculated quantity of fuel purchased by said fuel economy value to yield vehicle miles driven since a previous fuel purchase and adding said calculated miles driven to said mileage balance.

23. The method according to claim 22, wherein said price of fuel purchased is obtained from a transaction detail of said fuel purchase transaction.

24. The method according to claim 22, wherein said price of fuel purchased is a surrogate amount set by said issuer.

25. The method according to claim 22, wherein said vehicle information further includes a fuel type of said vehicle and said price of fuel purchased is a national average fuel price for said fuel type.

26. The method according to claim 22, wherein said fuel economy value is a surrogate amount set by said issuer.

27. The method according to claim 22, wherein said fuel economy value is a national average fuel economy value.

28. A computerized system for rewarding use of a payment product by the payment product holder, comprising:
a payment product provided by an issuer to a holder, said payment product representing funds available to said holder, said payment product providing means of payment for at least one transaction by said holder,
database storage means for storing information concerning a vehicle associated with said holder in associative relationship with information concerning said payment product, said vehicle information including a benchmark mileage of said vehicle,
means for automatically calculating a reward redeemable by said holder based on said at least one transaction and on miles traveled in said vehicle in excess of said benchmark mileage.

29. The system according to claim 28, further comprising means for determining whether said at least one transaction using said payment product is a qualifying transaction in compliance with pre-defined rewards eligibility criteria of said issuer, and wherein said means for automatically calculating a reward is effected only when said at least one transaction using said payment product is a qualifying transaction.

30. The system according to claim 28, further comprising means for providing for redemption by said holder of at least a portion of said calculated reward.

31. The system according to claim 30, further comprising means for accruing said calculated reward in an accrued rewards balance for said holder representing rewards earned by said holder less rewards redeemed by said holder, and means for fulfilling a request by said holder to redeem at least a portion of said calculated reward for at least one benefit when said accrued rewards balance is at least one of equal to and greater than a preselected threshold amount associated with said at least one benefit.

32. The system according to claim 28, further comprising means for automatically calculating an additional reward based on said at least one transaction and on miles traveled in said vehicle in excess of said benchmark mileage redeemable by said holder when said at least one transaction includes the purchase of at least one of goods and services from a provider thereof preselected by at least one of said issuer and a fulfillment representative of said issuer.

33. The system according to claim 28, further comprising means for accruing said miles traveled in said vehicle in excess of said benchmark mileage in an accrued mileage balance for said holder.

34. The system according to claim 33, further comprising means for updating said mileage balance based on an odometer reading for said vehicle associated with at least one of a service of said vehicle and an inspection of said vehicle.

35. The system according to claim 34, wherein said means for calculating a reward redeemable by said holder includes means for multiplying a monetary amount of said at least one transaction by a first percentage multiplier preselected by said issuer to yield a first reward component, means for multiplying said accrued mileage balance by a per mile monetary value preselected by said issuer to yield a second reward component, and means for multiplying said at least one transaction amount by a second preselected percentage multiplier proportional to said per mile monetary value to yield a second reward component cap, said reward equaling said second reward component up to said second reward component cap added to said first reward component.

36. The system according to claim 28, wherein said payment product is at least one of a credit card, a charge card, a debit card, a bank card, a smart card, and an automated teller machine card.

37. The system according to claim 28, wherein said vehicle information further includes at least one of a vehicle identification number, vehicle type, vehicle manufacturer, vehicle model, vehicle model year, and license plate number.

38. The system according to claim 28, further comprising means for providing said calculated reward to said holder in the form of a rebate payment.

39. The system according to claim 38, wherein said rebate payment is in the form of at least one of a check forwarded to said holder and a credit to a current account balance of said holder associated with said payment product.

40. The system according to claim 28, wherein said at least one transaction includes at least one of (i) cash advances made to said holder from said issuer, (ii) transfers of credit balances of said holder to a current account balance of said holder associated with said payment product, and (iii) finance charges incurred.

41. The system according to claim 28, further comprising means for verifying said benchmark mileage of said vehicle.

42. The system according to claim 28, further comprising means for verifying said miles traveled in said vehicle in excess of said benchmark mileage.

43. The system according to claim 28, wherein said at least one transaction is a vehicle fuel purchase and said miles traveled in said vehicle in excess of said benchmark mileage is accruable in an accrued mileage balance for said holder, and further comprising means for automatically updating said mileage balance based on said fuel purchase transaction.

44. The system according to claim 43, wherein said vehicle information further includes a fuel economy value for said vehicle, and said means for automatically updating said mileage balance based on said fuel purchase transaction includes means for dividing a fuel purchase total for said transaction by a price of fuel purchased to yield a quantity of fuel purchased, means for multiplying said calculated quantity of fuel purchased by said fuel economy value to yield vehicle miles driven since a previous fuel purchase and means for adding said calculated miles driven to said mileage balance.

45. The system according to claim 44, wherein said price of fuel purchased is obtained from a transaction detail of said fuel purchase transaction.

46. The system according to claim 44, wherein said price of fuel purchased is a surrogate amount set by said issuer.

47. The system according to claim 44, wherein said vehicle information further includes a fuel type of said vehicle and said price of fuel purchased is a national average fuel price for said fuel type.

48. The system according to claim 44, wherein said fuel economy value is a surrogate amount set by said issuer.

49. The system according to claim 44, wherein said fuel economy value is a national average fuel economy value.

50. A computerized method for rewarding financial services activity by a customer of a provider of financial services, the method comprising the steps of:
maintaining a financial services relationship between a financial service provider and a customer,
storing in at least one database information concerning a vehicle associated with said customer in associative relationship with information concerning said financial services relationship, said vehicle information including a benchmark mileage of said vehicle,
automatically calculating a reward redeemable by said customer based on at least one service associated with said financial services relationship and on miles traveled in said vehicle in excess of said benchmark mileage.

51. The method according to claim 50, further comprising the step of determining whether said at least one service is a qualifying service in compliance with pre-defined rewards eligibility criteria of said services provider, and wherein said step of calculating a reward is effected only when said at least one service is a qualifying service.

52. The method according to claim 50, further comprising the step of providing for redemption by said customer of at least a portion of said calculated reward.

53. The method according to claim 50, wherein said miles traveled in said vehicle in excess of said benchmark mileage is accruable in an accrued mileage balance for said customer.

54. The method according to claim 50, further comprising the step of updating said mileage balance based on an odometer reading for said vehicle associated with at least one of a vehicle service and a vehicle inspection.

55. The method according to claim 50, wherein said at least one service is associated with a monetary loan by said financial services provider to said customer.

56. The method according to claim 55, further comprising the step of providing said calculated reward to said customer in the form of a reduced rate on said loan.

57. The method according to claim 50, wherein said at least one service is associated with investment servicing by said financial services provider for said customer.

58. The method according to claim 57, further comprising the step of providing said calculated reward to said customer, and wherein said calculated reward is in the form of a reduced charge for said investment servicing.

59. The method according to claim 50, wherein said step of calculating said reward is effected on a periodic basis.

60. The method according to claim 50, further comprising the step of verifying said benchmark mileage of said vehicle.

61. The method according to claim 50, further comprising the step of verifying said miles traveled in said vehicle in excess of said benchmark mileage.

62. A computerized system for rewarding financial services activity by a customer of a provider of financial services, comprising:
means for storing information concerning a vehicle associated with said customer in associative relationship with information concerning said financial services, said vehicle information including a benchmark mileage of said vehicle, and
means for automatically calculating a reward redeemable by said customer based on at least one service associated with said financial services and on miles traveled in said vehicle in excess of said benchmark mileage.

63. The system according to claim 62, further comprising means for determining whether said at least one service is a qualifying service in compliance with pre-defined rewards eligibility criteria of said services provider, and wherein said reward is calculated only when said at least one service is a qualifying service.

64. The system according to claim 62, further comprising means for providing for redemption by said customer of at least a portion of said calculated reward.

65. The system according to claim 62, further comprising means for accruing said miles traveled in said vehicle in excess of said benchmark mileage in an accrued mileage balance for said customer.

66. The system according to claim 62, further comprising means for automatically updating said mileage balance based on an odometer reading for said vehicle associated with at least one of a vehicle service and a vehicle inspection.

67. The system according to claim 62, wherein said at least one service is associated with a monetary loan by said financial services provider to said customer.

68. The system according to claim 67, wherein said calculated reward to said customer is in the form of a reduced rate on said loan.

69. The system according to claim 62, wherein said at least one service is associated with investment servicing by said financial services provider for said customer.

70. The system according to claim 69, wherein said calculated reward to said customer is in the form of a reduced charge for said investment servicing.

71. The system according to claim 62, further comprising means for verifying said benchmark mileage of said vehicle.

72. The system according to claim 62, further comprising means for verifying said miles traveled in said vehicle in excess of said benchmark mileage.

73. A computerized method for rewarding financial services activity by a customer of a provider of financial services, the method comprising the steps of:
maintaining a financial services relationship between a financial service provider and a customer, and
automatically calculating a reward redeemable by said customer based on at least one service associated with said financial services relationship and on miles traveled in a vehicle by said customer.

74. The method according to claim 73, further comprising the step of determining whether said at least one service is a qualifying service in compliance with pre-defined rewards eligibility criteria of said services provider, and wherein said step of calculating a reward is effected only when said at least one service is a qualifying service.

75. The method according to claim 73, wherein said calculated reward is accruable in an accrued rewards balance for said customer representing rewards earned by said customer less rewards redeemed by said customer.

76. The method according to claim 73, wherein said miles traveled in said vehicle is accruable in an accrued mileage balance for said customer.

77. The method according to claim 76, further comprising the steps of storing in at least one database information concerning a benchmark mileage of said vehicle in associative relationship with information concerning said customer, and updating said mileage balance based on an odometer reading for said vehicle associated with at least one of a service of said vehicle and an inspection of said vehicle.

78. The method according to claim 76, further comprising the step of updating said mileage balance based on a vehicle fuel purchase transaction by said customer.

79. The method according to claim 73, further comprising the step of providing for redemption by said customer of at least a portion of said calculated reward.

80. The method according to claim 79, further comprising the step of providing at least a portion of said calculated reward to said customer in the form of a rebate payment.

81. The method according to claim 80, wherein said rebate payment is in the form of at least one of a check forwarded to said customer and a credit to a financial account balance of said customer.

82. The method according to claim 79, further comprising the step of providing at least a portion of said calculated reward to said customer in the form of at least one of (i) a reduced rate on a loan by said financial services provider to said customer and (ii) a reduced charge for investment servicing by said financial services provider for said customer.

83. The method according to claim 73, wherein said financial services relationship between said financial services provider and said customer is that of a payment product issuer and a payment product holder, said payment product being at least one of a credit card, a charge card, a debit card, a bank card, a smart card, and an automated teller machine card.

84. A computerized system for rewarding financial services activity by a customer of a provider of financial services, comprising means for automatically calculating a reward redeemable by said customer based on at least one service associated with said financial services activity and on miles traveled in a vehicle by said customer.

85. The system according to claim 84, further comprising means for determining whether said at least one service is a qualifying service in compliance with pre-defined rewards eligibility criteria of said services provider, and wherein said reward is calculated only when said at least one service is a qualifying service.

86. The system according to claim 84, wherein said calculated reward is accruable in an accrued rewards balance for said customer representing rewards earned by said customer less rewards redeemed by said customer.

87. The system according to claim 84, wherein said miles traveled in said vehicle is accruable in an accrued mileage balance for said customer.

88. The system according to claim 87, further comprising database means for storing information concerning a benchmark mileage of said vehicle in associative relationship with information concerning said customer, and means for updating said mileage balance based on an odometer reading for said vehicle associated with at least one of a service of said vehicle and an inspection of said vehicle.

89. The system according to claim 87, further comprising means for updating said mileage balance based on a vehicle fuel purchase transaction by said customer.

90. The system according to claim 84, wherein at least a portion of said calculated reward to said customer is in the form of a rebate payment.

91. The system according to claim 90, wherein said rebate payment is in the form of at least one of a check forwarded to said customer and a credit to a financial account balance of said customer.

92. The system according to claim 84, wherein at least a portion of said calculated reward to said customer is in the form of at least one of (i) a reduced rate on a loan by said financial services provider to said customer and (ii) a reduced charge for investment servicing by said financial services provider for said customer.

93. The system according to claim 84, wherein said financial services provider is a payment product issuer and said customer is a holder of said payment product, said payment product being at least one of a credit card, a charge card, a debit card, a bank card, a smart card, and an automated teller machine card.
